(19) United States
(12) Patent Application Publication
(10) Pub. No.: US 2016/0140514 A1
(43) Pub. Date: May 19, 2016

(54) Proactive Management of Devices

(71) Applicant: HEWLETT-PACKARD DEVELOPMENT COMPANY, L.P., Fort Collins, CO (US)

(72) Inventors: Hadas KOGAN, Haifa (IL); Doron SHAKED, Haifa (IL); Ayelet PNUELI, Haifa (IL)

(21) Appl. No.: 14/898,274

(22) PCT Filed: Jun. 14, 2013
(86) PCT No.: PCT/US13/45819

§ 371 Date: Dec. 14, 2015

(51) Int. Cl. G06Q 10/00; G06Q 10/06

(52) U.S. Cl. CPC G06Q 10/20; G06Q 10/06312

(57) ABSTRACT

Proactive management of devices provided at a site includes, responsive to an indication that a part of a device at a site needs to be replaced at a specified replacement time, determining additional parts for replacement at the specified replacement time.

### BACKGROUND

A service may manage a plurality of printer fleets each including a plurality of printers. The service for managing printers, in part, may also be responsible for a continuous operation of the printers which includes break fix (B&F) maintenance for replacing parts (B&F parts) upon breakage and proactive maintenance (PM) for replacing parts, e.g. proactive maintenance parts (PM parts), at a certain usage level.

### DESCRIPTION OF THE DRAWINGS

FIG. 1 is a schematic representation of a system including a plurality of printers at different sites managed by a service for managing printers,

FIG. 2 is a flow diagram of a method for the proactive management of printers, and

FIG. 3 is a functional block diagram illustrating a system for the proactive management of printers.

### DETAILED DESCRIPTION

In a service which may manage many printer fleets each including a plurality of printers there are several approaches to reduce the overall cost of maintenance. A proactive policy trades the additional breakage cost for increased maintenance cost. A proactive policy does that by identifying parts to be replaced while still intact. Proactive maintenance parts can have a prescribed replacement at usage levels assuring that they break very seldom. In addition and on top of proactive maintenance optimizations, policies may further optimize the maintenance execution. When the latest time at which parts may be replaced can be securely determined, an optimization policy can minimize cost by scheduling the maintenance at earlier times.

Currently used maintenance policies are simple. For example, one may think of replaceable parts as having alert lights. When a part breaks its alert light flashes red. Proactive parts are ‘programmed’ to flash red at a prescribed usage level. Any red light condition will call for a replacement of the part concerned.

In accordance with the examples described here, in addition to the red light condition, an additional condition is considered which may be termed “yellow light” condition and which indicates a “Replace-if-on-site” condition. In case a technician is on the site due to a red light condition of another part it is checked whether another part should also be replaced during this visit of the technician. Both, red and yellow light conditions may be triggered dependent on variable parameters such as service level agreements, local labor cost, size of the site, and replacement schedules of other parts whose service is due soon. An adaptive maintenance policy will be described where red light conditions are fixed, and yellow light conditions are optimized.

In accordance with an example, in a method for proactive management of a plurality of devices provided at a site, each device including at least one replaceable part, responsive to an indication that a part of a device at a site needs to be replaced at a specified replacement time, additional parts from the device or from other devices at the site are determined for replacement at the specified replacement time, the additional parts having associated therewith replacement times different from the specified replacement time. The additional parts to be replaced at the specified replacement time are determined dependent on the cost for the replacement and the time until a next replacement time. Then the part and the additional parts are replaced at the specified time. The indication that a part of a device at a site needs to be replaced may be termed a red light condition meaning that the part needs to be replaced at the specified replacement time which is now or immediately, e.g. in case of a part managed in accordance with a B&F (B&F=Beak and Fix) management policy. In addition, a red light condition may mean that the part needs to be replaced proactively.

In the following, examples of an optimal maintenance policy for the proactive maintenance of devices will be described with reference to printers. Technicians visiting a site will replace parts of devices at the site whose replacement due to breakage or proactive schedules are imminent. Replacing parts of printers at a site prematurely while technician is already on site saves future technician commute costs and allows bundling replacements which allows savings in shipment and labor cost.

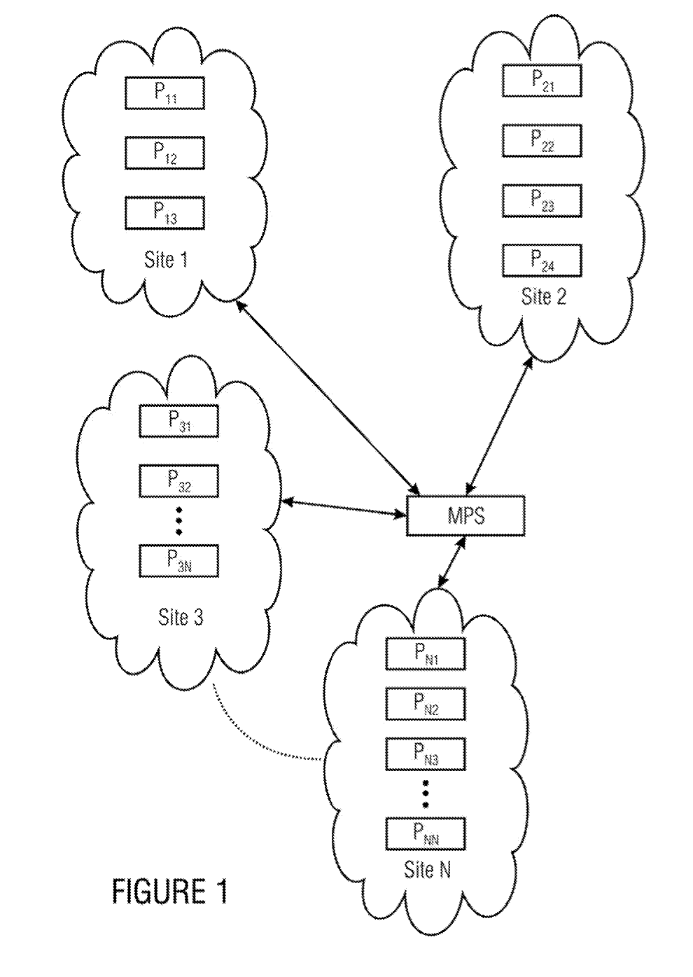

FIG. 1 shows a schematic representation of a system in which the approach described in the following may be implemented. The system comprises a plurality of sites Site 1, Site 2 . . . Site N. Each site includes a plurality of hardware devices, for example a plurality of printers P₁₁ to P_{NN}. Site 1 may have N1 parts, and Site 2 may have N2 part, however, it is noted that N1 is not necessarily equal to N2. An example of the system of FIG. 1 is a management system for managing different printer fleets each including printers. The number of printers at the respective sites may differ and a plurality of sites may be associated with the same printer fleet. Further, the system includes a service for managing printers that is operative to manage the respective printers at the respective sites, as indicated by the respective double headed arrows. The service, inter alia, is responsible for the continuous operation of the respective printers at the respective sites and for applying for example a proactive maintenance for replacing parts of the respective printers prematurely so that, for example the service for managing printers schedules a time at which at a part of a specific printer at a specific site may be replaced. The service for managing printers will cause a technician to be present at the site and also will cause the shipment of the replacement part, for example the proactive maintenance part, to the site so that the technician can perform the maintenance.

It is noted that FIG. 1 shows an example of a system in which a plurality of printers P₁₁ to P_{NN} are to be managed, however, also other devices may be managed, for example other devices in the field of computers, like servers, hard disks and the like, but also hardware devices in other fields having parts which may be replaced on a regular basis, for example a plurality of manufacturing machines requiring maintenance may be served by the service.

In the following, examples for a maintenance policy will be described with regard to the system of FIG. 1.

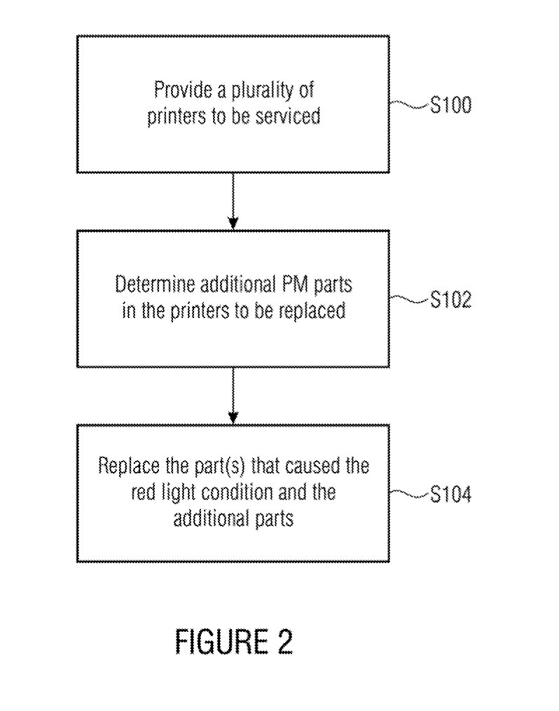

FIG. 2 shows a flow diagram of a method for proactive management of printer devices, for example the devices shown in FIG. 1. In a step S100 a plurality of printers to be serviced by a service for managing printers is provided. In a step S102, in case of a red light condition at one of the sites (e.g. one of the printers called for the replacement of one of its part), additional parts in the printer having the red light condition and/or additional parts in other printers at the site having the yellow light condition are determined in accordance with the approached described in further detail below. Once the additional parts have been determined, in step 104 these additional parts and the part that caused the red light condition will be replaced. It is noted that so far a situation was described in which one part caused a red light condition, however, it may also be that a plurality of parts cause a red light condition at the same time. In such a case, all parts that caused the red light condition and the additional parts will be replaced.

Before describing details of examples for determining the additional parts, consider the following. If there are two parts to replace on one site, one technician will be send to the site to replace both. Also, if a part's replacement is scheduled for tomorrow, it makes sense to ask the technician there today to make the replacement, although a good day's operation of the additional part is wasted. This also applies to more than a single day. The following examples determine how far into the future the replacement of parts should be extended. This will depend on many variables. For example, since smaller sites will see fewer visits their proactive policy should look farther into the future. Another factor is the ratio between labor and part costs. When applying a proactive policy, labor costs may be saved, while a little more needs to be paid for the extra parts. E.g., when parts are very expensive their replacement may be avoided as long as possible, when labor is expensive more parts may be replaced to reduce the likelihood of the overhead due to an additional trip the technician might need to do.

In accordance with one example, the goal of the maintenance policy is to minimize the total cost per time, where the cost includes labor and parts. A technician will be dispatched on a red light condition which cannot be affected, however, the additional work the technician will perform on the site can be affected (yellow light condition).

Let a site S be the location of a fleet with N replaceable parts. The cost for a technician visit to the site is a flat V_{S}. When the usage level for the i^{th} part is Uᵢ and the failure probability density function as a function of the utility u is ƒᵢ(u), the current failure distribution as a function of time t≧0 is

$${h}_{i}^{{U}_{i}} ( t ) = \frac{{f}_{i} ( {U}_{i} + t \cdot {r}_{i} )}{{\int }_{{U}_{i}}^{∞} {f}_{i} ( τ ) d r} ,$$

where rᵢ is the utilization rate (e.g. 9,000 pages per month).

This example of the maintenance policy prescribes premature replacements trying to minimize the cost of maintenance. Instead of minimizing the overall cost per time, it does that in a greedy way by minimizing the expected cost per time until the next red light condition or incident.

When denoting a set of part indices slated for replacement as I⊂(1, 2, . . . N_{S}) the number of additional parts to be replaced is determined as follows:

argmin_{I}E{(Cost|I)/(Time|I)}.

wherein:
E denotes the expectation.
Cost|I denotes the cost for replacing part in I, and
Time|I denotes the time until the replacement time assuming replacement I.

In accordance with examples, argmin_{I}E{(Cost|I)/(Time|)} may be determined as follows:

$${arg min}_{l} \frac{{V}_{S} + {\sum }_{i ∈ I}^{ } {c}_{i} \frac{{M}_{1} ( {h}_{i}^{{U}_{i}} )}{{M}_{1} ( {h}_{i}^{0} )}}{{M}_{0} ( {\prod }_{i ∉ l} ( 1 - {H}_{i}^{{U}_{i}} ( t ) ) {\prod }_{i ∈ l} ( 1 - {H}_{i}^{0} ( t ) ) )}$$

wherein:
V_{S} is the flat cost for a technician visit to the site,
cᵢ is the cost of a new part for replacing the i^{th} part,
Uᵢ is the usage level for the i^{th} part,

$${h}_{i}^{{U}_{i}} ( t ) = \frac{{f}_{i} ( {U}_{i} + t \cdot {r}_{i} )}{{\int }_{{U}_{i}}^{∞} {f}_{i} ( τ ) d τ}$$

is the current failure distribution for the i^{th} part to be replaced as a function of time t≧0, where rᵢ is a utilization rate of the part and fᵢ(u) is the failure probability density function as a function of the utility u,

$${h}_{i}^{0} ( t ) = \frac{{f}_{i} ( 0 + t \cdot {r}_{i} )}{{\int }_{0}^{∞} {f}_{i} ( τ ) d τ} ,$$

is the current failure distribution for the new part to replace the i^{th} part,
M is the moment operator, e.g. M₁(f) is the first moment of f,
Hᵢ^{U}^{ᵢ}(t) is the cumulative conditional distribution function distribution for the i^{th} part to be replaced, and
Hᵢ⁰(t) is the cumulative conditional distribution function distribution for the new part to replace the i^{th} part

The above described example is advantageous both in determining an explicit criterion as well as in making it possible to approximate it efficiently. Instead of checking all N! different possibilities for I, an order is assumed, namely what would be the ‘next’ part to replace? The order may correspond to the likely failure order, e.g. according to the mean or median failure probability.

In accordance with another maintenance policy the maintenance efficiency or the ratio of time to maintenance cost is maximized, where the cost, again, includes labor and parts. A technician will be dispatched on a red light condition which cannot be affected, however, the additional work the technician will perform on the site can be affected (yellow light condition). At the time of a replacement the number of PM parts replaced at the same time is selected such that the ratio of time to maintenance cost is maximized.

A site, e.g. one of the sites Site 1, . . . Site N of FIG. 1, to be visited by a technician for replacing a PM part is denoted “S”. It is assumed that the site S is the location of a plurality of printers with N_{S} PM parts. The cost for a technician to visit a site is V_{S}. Further, the proactive replacement times for the respective parts are 0=t₀<t₁<t₂< . . . <t_{N}_{_{S}}₋₁, and without loss of generality, the indices are ordered. Thus, when considering N_{S} PM parts a first PM part is to be replaced at a replacement time t₀, a second PM part is to be replaced at a replacement time t₁ which is later than replacement time t₀, as is known from the replacement times associated with each of the PM parts. Tᵢ is life time (replacement level) of the i^{th} PM part until its replacement, tᵢ is the time (the portion of its life time Tᵢ) the i^{th} PM part has been used, and cᵢ denotes the cost of the i^{th} PM part. The replacement of the i^{th} PM part at the time t is denoted as rᵢ(t), with t≦tᵢ. The marginal cost for rᵢ(t) is

Cᵢ(t)=cᵢ·(tᵢ−t)/Tᵢ

i.e. it is the part of the cost of the part proportional to the part's life wasted by the premature replacement.

In accordance with the maintenance policy described here, replacement events are considered where more than one part is replaced at the same time. Such events are denoted R_{I}(t)={rᵢ(t)|iεI}. The indices in I may be consecutive so that the same time replacements of consecutive PM parts is given as follows:

Rₖ^{l}(t)={rₖ(t),rₖ₊₁(t), . . . rₗ(t)}

Thus, a replacement event may involve a plurality of PM parts, for example the k^{th} PM part, the k+1^{th} PM part until the l^{th} PM part, which are replaced at the same time irrespective of the actual replacement time associated with the part in the first place. The cost associated with the replacement event Rₖ^{l}(t) denoted as follows:

$$C ( {R}_{k}^{l} ( t ) ) = {V}_{S} + {\sum }_{i = k}^{l} {C}_{i} ( t )$$

with i=1, 2, . . . N. The method for proactive management of a plurality of printers determines a number of parts to be replaced at the same time on the basis of the cost of the replacement event, during which a plurality of parts having associated therewith different replacement times are replaced at the same time. The number of replacements (the replacement event) at a time t₀ of a replacement may be determined as follows:

$${R}_{0}^{{i}^{*}} ( {t}_{0} ) , such that {i}^{*} = arg {max}_{i} \frac{{t}_{i + 1}}{c ( {R}_{0}^{i} ( {t}_{0} ) )} .$$

The above described approaches yield substantial savings on the maintenance cost. More specifically, alternative maintenance policies were compared in a simulation based on real sites. The real numbers included the printer fleets, more specifically what kind of printers and how many of each are included in the fleet, the list of PM parts for every printer and their cost, and, in addition, for each printer the number of pages printed by month and the expected variation in that number as considered. The results of applying a current approach and the above described new approaches have been compared and when compared to replacing parts only on red light conditions. The above described approaches allow for significant savings.

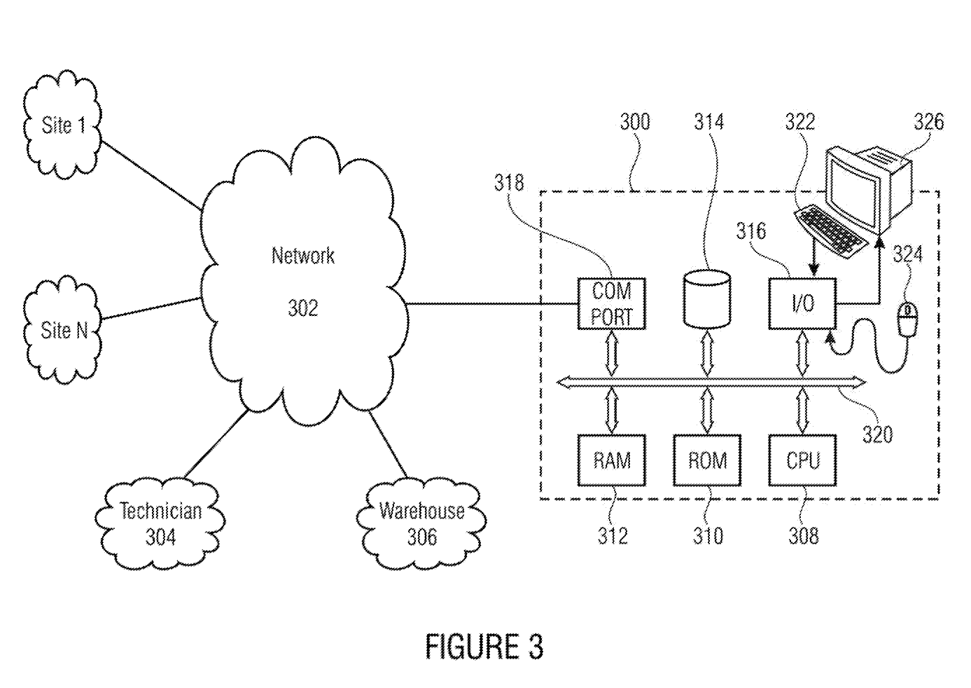

FIG. 3 is a functional block diagram illustrating a system for the proactive management of printers. FIG. 3 shows a computer 300 for implementing a part of the proactive management of printers. The computer 300 is connected via a network 302 to the plurality of sites Site 1 . . . Site N for receiving a red light condition from a printer. The computer 300 is implemented to determine for the site from which the red light condition was received the additional parts for replacement as described in detail above. The computer 300 may further be connected, via the network 302, to a location at which a technician 304 is based. Also, the computer 306 may be connected, via the network 302, to a warehouse 306 or to respective suppliers for the replacement parts. From the warehouse 306 the replacement parts are shipped to the respective site in response to a corresponding order received from the computer 300. The technician 304 and/or the warehouse 306 and the computer 300 may be at the same location. In this case, the connection may be via an intranet at the common location. The computer 300 is implemented to generate, on the basis of the determination of the additional replacement parts, respective messages causing the technician 306 to visit the site and do the replacements. The messages may include information for the technician 306 what printer caused the red light condition and what part in the printer and what additional parts in this printer or in other printers are also to be replaced. In addition, messages may be generated that cause ordering and shipping of replacement parts from the warehouse 306 to the site. Instead of shipping the replacement parts, they may also be picked up by the technician on his way to the site.

As is shown in FIG. 3, the computer may include a central processing unit (CPU) 308, a memory 310, 312, 314, an input/output (I/O) port 316, a communication port 318 and an interconnect bus 320. The CPU 308 may include a single microprocessor, or it may include a plurality of microprocessors for configuring the CPU 308 as a multi-processor system. The memory may include a main memory 312, such as a dynamic random access memory (DRAM) and cache, and a read only memory 310, such as a PROM, an EPROM, a FLASH-EPROM or the like. The memory may also include a mass storage device 314 such as a disk drive, tape drive, etc. The I/O port 316 allows for the connection of a user interface element, e.g. a keyboard 322, a pointing device 324, like a mouse, and a display device 326, like a monitor. FIG. 3 illustrates a computer with user interface elements, as may be used to implement a personal computer or other type of work station or terminal device. It may also be implemented as a network or host computer platform, as may typically be used to implement a server. In this case the user interface elements may be omitted. The communication port 318 may provide for a data communication with the respective sites Site 1, Site 2 . . . Site N, the technician 304 and the warehouse 306 as described above. The data communication may be via the network 302, e.g., to enable sending and receiving the messages electronically. The physical communication links may be optical, wired, or wireless. In operation, the main memory 312 may store at least portions of instructions for execution by the CPU 300 and data for processing in accord with the executed instructions for determining for the site from which the red light condition was received the additional parts for replacement as described in detail above, and for generating the messages. The instructions may be uploaded from a computer readable medium, e.g., from mass storage 306. The mass storage 306 may include a magnetic disk, a tape drive or a disk drive, for storing the instructions for use by the CPU 300.

Although some examples have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Examples may be implemented in hardware or in machine readable instructions. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

A data carrier may be provided having electronically readable control signals, which are capable of cooperating with a programmable computer system, such that one of the methods described herein is performed.

Generally, a non-transitory computer program product with a program code may be provided, the program code being operative for performing one of the methods when the computer program product runs on a computer. The program code may for example be stored on a machine readable carrier. The non-transitory computer program for performing one of the methods described herein may be stored on a machine readable carrier.

Further a processing unit may be provided, for example a computer, or a programmable logic device, which is configured to or adapted to perform one of the methods described herein. A computer may have installed thereon the computer program for performing one of the methods described herein. Also a programmable logic device such as a FPGA (field programmable gate array) or an AISIC (application specific integrated circuit) may be used to perform some or all of the functionalities of the methods described herein. A field programmable gate array may cooperate with a microprocessor in order to perform one of the methods described herein. Generally, the methods may be performed by any hardware apparatus.

It is understood that modifications and variations of the arrangements and the details described herein will be apparent to others skilled in the art. It is the intent, therefore, to be limited by the scope and spirit of the following claims and not by the specific details presented by way of description and explanation of the examples herein.

1. A method for proactive management of devices provided at a site, each device including at least one replaceable part, the method comprising:
responsive to an indication that a part of a device at a site needs to be replaced at a specified replacement time, determining additional parts from the device or from other devices at the site for replacement at the specified replacement time, the additional parts having associated therewith failure probabilities or replacement times at a time later than the specified replacement time, wherein the additional parts to be replaced at the specified replacement time are determined dependent on the cost for the replacement and the expected time until a next replacement; and
replacing the part and the additional parts at the specified time.

2. The method of claim 1, wherein the cost comprise the cost of the parts to be replaced and the cost of a technician to visit the site.

3. The method of claim 2, wherein
an expensive part is replaced at a time closer to its expected failure or specified replacement time when compared to a part being less expensive which is replaced at a time farther away from its expected failure or specified replacement time, or
when the cost of a technician to visit the site is high, the number of parts replaced during a visit of the technician is high when compared to the number of parts replaced during a visit of the technician when the cost of a technician to visit the site is low.

4. The method of one of claims 1 to 3, wherein the cost further comprises the size of the site, and wherein, when the size of the site is large, the expected failure or specified replacement time of replaced parts is more imminent than as compared to the expected failure or specified replacement time of replaced parts when the size of the site is small, which is farther in the future.

5. The method of one of claims 1 to 4, wherein the additional parts are determined such that the cost per time until the next replacement time is minimized.

6. The method of claim 5, wherein, when considering a set of additional parts to be replaced, the additional parts from the set are determined such that the expectation of the ratio of the cost for replacing a number of additional parts and the time at which the last of the additional parts is to be replaced is minimized.

7. The method of claim 6, wherein the additional parts from the set are determined as follows:
$${arg min}_{l} E \{ ( Cost \vert I ) / ( Time \vert I ) \}$$
wherein:
the set of parts to be replaced are denoted as I⊂(1, 2, . . . N),
E denotes the expectation,
Cost|I denotes the cost for replacing part in I, and
Time|I denotes the time until the replacement time assuming replacement I.

8. The method of claim 7, wherein argmin_{I}E{(Cost|I)/(Time|I)} is determined as follows:
$${arg min}_{l} \frac{{V}_{S} + {\sum }_{i ∈ I}^{ } {c}_{i} \frac{{M}_{1} ( {h}_{i}^{{U}_{i}} )}{{M}_{1} ( {h}_{i}^{0} )}}{{M}_{0} ( {\prod }_{i ∈ l} ( 1 - {H}_{i}^{{U}_{i}} ( t ) ) {\prod }_{i ∈ l} ( 1 - {H}_{i}^{0} ( t ) ) )}$$
wherein:
V_{S} is the flat cost for a technician visit to the site,
cᵢ is the cost of a new par for replacing the i^{th} part,
Uᵢ is the usage level for the i^{th} part,
$${h}_{i}^{{U}_{i}} ( t ) = \frac{{f}_{i} ( {U}_{i} + t \cdot {r}_{i} )}{{\int }_{{U}_{i}}^{∞} {f}_{i} ( τ ) d τ}$$
is the current failure distribution for the i^{th} part to be replaced as a function of time t≦0, where rᵢ is a utilization rate of the part and fᵢ(u) is the failure probability density function as a function of the utility u,
$${h}_{i}^{0} ( t ) = \frac{{f}_{i} ( 0 + t \cdot {r}_{i} )}{{\int }_{0}^{∞} {f}_{i} ( τ ) d τ} ,$$
is the current failure distribution for the new part to replace the i^{th} part,
M is the moment operator, e.g. M₁ (f) is the first moment of f,
Hᵢ^{U}^{ᵢ}(t) is the cumulative conditional distribution function distribution for the i^{th} part to be replaced, and
Hᵢ⁰(t) is the cumulative conditional distribution function distribution for the new part to replace the i^{th} part.

9. The method of one of claims 1 to 4, wherein the additional parts or specified replacement time are determined such that the time per cost until the next replacement time are maximized.

10. The method of claim 9, wherein, when considering a set of additional parts to be replaced, the number of additional parts from the set are determined such that the ratio of the time at which the last of the additional parts it to be replaced and the cost for replacing a number of additional parts is maximized.

11. The method of claim 10, wherein the number of additional parts to be replaced is determined as follows:
$${R}_{0}^{{i}^{*}} ( t ) , such that {i}^{*} = arg {max}_{li} \frac{{t}_{i + 1}}{c ( {R}_{0}^{i} ( t ) )} ,$$
wherein
R₀ⁱ(t₀) denotes a replacement event for replacing parts 0, 1, 2, . . . , I, where parts are ordered according to increasing specified replacement times; and
C(R₀^{iI}(t))=V_{S}+Σⱼ₋₀ⁱCⱼ(t) denotes the costs for the replacement event, wherein V_{S} denotes the cost of a technician to visit the site, Cⱼ(t) denotes the marginal cost of the replacement of part j at time t, the marginal cost being the part of the costs of the part proportional to the part's life time wasted by the premature replacement.

12. The method of one of claims 1 to 11, wherein the devices comprise a plurality of printers.

13. A non-transitory computer readable medium comprising a computer program including instructions for proactive management of devices provided at a site, each device including at least one replaceable part, when being executed by a computer, wherein the instruction comprise:
instructions to determine, responsive to an indication that a part of a device at a site needs to be replaced at a specified replacement time, additional parts from the device or from other devices at the site for replacement at the specified replacement time, the additional parts having associated therewith failure probabilities or replacement times at a time later than the specified replacement time, wherein the additional parts to be replaced at the specified replacement time are determined dependent on the cost for the replacement and the expected time until a next replacement; and
instructions to generate a message to cause a technician and the replacement parts to be dispatched to the site.

14. A system for proactive management of devices, comprising:
a network;
a plurality of printers arranged at a common site; and
a computer connected to the plurality of printers via the network and configured to
receive from one of the printers an indication that a part of the printer needs to be replaced at a specified replacement time;
determine, responsive to the received indication, additional parts from the device or from other devices at the site for replacement at the specified replacement time, the additional parts having associated therewith failure probabilities or replacement times at a time later than the specified replacement time, wherein the additional parts to be replaced at the specified replacement time are determined dependent on the cost for the replacement and the expected time until a next replacement; and
generate a message to cause a technician and the replacement parts to be dispatched to the site.

15. The system of claim 14, wherein the technician is based at the location of the computer.
